(19) United States
(12) Patent Application Publication
(10) Pub. No.: US 2008/0289106 A1
(43) Pub. Date: Nov. 27, 2008

(54) AUTOMATICALLY CORRECTING THE POSITION OF A PATIENT SUPPORT FOR A TARGETED IRRADIATION OF A PATIENT

(76) Inventors: Lukas Beyer, Hamburg (DE); Dieter Heinl, Erbendorf (DE); Jochen Miguel Loseken, Bayreuth (DE)

Correspondence Address: BRINKS HOFER GILSON & LIONE, P.O. BOX 10395, CHICAGO, IL, 60610, US

(21) Appl. No.: 12/122,105

(22) Filed: May 16, 2008

(30) Foreign Application Priority Data
May 23, 2007 (DE) 10 2007 023 919.1

(51) Int. Cl. A61G 7/018; B25J 9/16

(52) U.S. Cl. 5/601; 700/253; 901/2

(57) ABSTRACT

A method for automatically correcting the position of a patient support for a targeted irradiation of a patient is provided. The patient support correction is carried out according to patient data. A patient support deformation occurring as a result of the positioning the patient on the couch is calculated from the patient data. The position of the patient couch is then adjusted according to the calculated patient support deformation for a targeted irradiation. The method enables a more accurate irradiation of patient.

This patent document also claims the benefit of DE 10 2007 023 919.1, filed May 23, 2007, which is hereby incorporated by reference.

### BACKGROUND

The present embodiments relate to automatically correcting the position of a patient support (couch) for a targeted irradiation of a patient.

In the field of medicine, a patient is irradiated using different technologies (e.g. x-rays, ultrasound, ion radiation) for therapeutic or diagnostic purposes. The beam is aligned with the diseased tissues as best as possible because it is essential to the success of the treatment. For example, during therapeutic irradiation (e.g. gamma rays, particles), beam alignment is essential to the success of the treatment.

The success of a tumor treatment depends, for example, on the accuracy of the tumor irradiation and/or the accuracy of the radiation alignment on the tumor. Alignment is influenced by the patient support and the rigidity of the patient support system employed and naturally the stretcher board fastened thereupon. The elastic deformation and the inaccuracy with the positioning are approximately directly proportional to the patient weight. The demands with respect to the admissible patient weight (currently 200 kg) and the rigidity requirements placed on the system constantly increase. A significant component comes from the patient support or stretcher board. The use of ultra stiff materials such as CFK (carbon fiber reinforced plastic) achieves a minimal deflection, but this still amounts to values of more than 10 mm viewed across the stretcher board. A deformation of 10 mm or more is a deformation that may significantly influence the success of the therapy, precisely for therapy applications.

### SUMMARY AND DESCRIPTION

The present embodiments may obviate one or more of the drawbacks or limitations of the related art. For example, in one embodiment, a patient may be positioned for precise irradiation.

In one embodiment, an automatic correction of the position of a patient support (couch or stretcher board) for a targeted irradiation of a patient is performed. The position is corrected in accordance with patient data. A patient support deformation occurring as a result of the positioning of the patient on the patient support is calculated on the basis of the patient data. The position of the patient support is adjusted for a targeted irradiation by a robot system, for example, according to the calculated patient support deformation.

The deformation of the patient support caused by the patient is compensated using the adjusting device. This achieves a more accurate adjustment of the beam and thus a better treatment (or a more precise diagnosis with diagnostic irradiation).

The exact bending behavior of the patient support influenced by a patient may not be determined. When preparing the irradiation treatment, not all patient data (body shape and weight distribution) which is relevant to the deformation of the stretcher board may be determined. A precise calculation is associated with a high outlay by virtue of the irregularity of the body shape and the material properties of the patient support. Two measurements may be used to compensate for the patient support deformation.

In one embodiment, the patient's weight and an item of information relating to the position of the center of gravity of the patient may be used as patient data for position correction purposes. The information is given, for instance, by the distance of the center of gravity (possibly projected in a certain direction) of a supporting point. With a supporting surface, the supporting point may be the distance from a central point of this surface. These two items of information provide for a simplified description of the bending of the patient support produced by the patient. Further patient-related information may be added to refine this description.

In one embodiment, an empirically obtained patient support-specific formula may be used to compensate for the patient support bending. The empirical adjustment of the formula to the patient support properties of a patient support may achieve a high level of accuracy. An analytical description would alternatively be possible.

In one embodiment, a coordinate system is defined. The x-axis is essentially parallel to the longitudinal direction of the non-loaded (i.e. no patient and/or no bending) patient support and/or of the non-loaded patient support. A dominating part of the patient support surface is parallel to the x-axis. The y-axis is parallel to the transverse direction of the non-loaded couch and the z-axis is orthogonal to the two other axes (i.e. orthogonal to the patient support). The description of the axis is not to be interpreted as restrictive and the specification of the coordinate system is only to be understood as restrictive in order to describe the following developments.

In one embodiment, a formula is used, which describes the position change in the z-direction as a function of the x-position, the patient weight and an item of information relating to the position of the center of gravity (e.g. the x-distance of the center of gravity from a robot hand supporting the patient support). The function may depend on further variables, for example, on a z-position. Using further variables may achieve a more significant accuracy. A function for a position change in the x-direction or y-direction may be established, which depends on the same variables.

The function may be formed from a superimposition of test functions, the coefficients of which were determined by a patient support-specific adjustment and/or a fit. Possible test functions may be monomials, which superimpose polynomials, for example, or trigonometric functions.

In one embodiment, a device for automatic correction of the position of a patient support for a targeted irradiation of a patient is provided. The device includes a calculation device that calculates a patient support deformation occurring as a result of the positioning the patient on the basis of patient data, for example, software or hardware, and an adjustment device that adjusts the position of the patient support according to the calculated patient support deformation for a targeted irradiation, for example, a robot construction.

### BRIEF DESCRIPTION OF THE DRAWINGS

FIG. 1 shows one embodiment of a robot arm having several degrees of freedom for adjusting the stretcher board (patient support or couch) position

FIG. 2 shows a schematic of one embodiment of stretcher board deformation

FIG. 3 shows a schematic of a patient on one embodiment of a stretcher board

FIG. 4 shows an evaluation of stretcher board series of measurements in order to determine an empirical formula for the stretcher board deformation.

### DETAILED DESCRIPTION

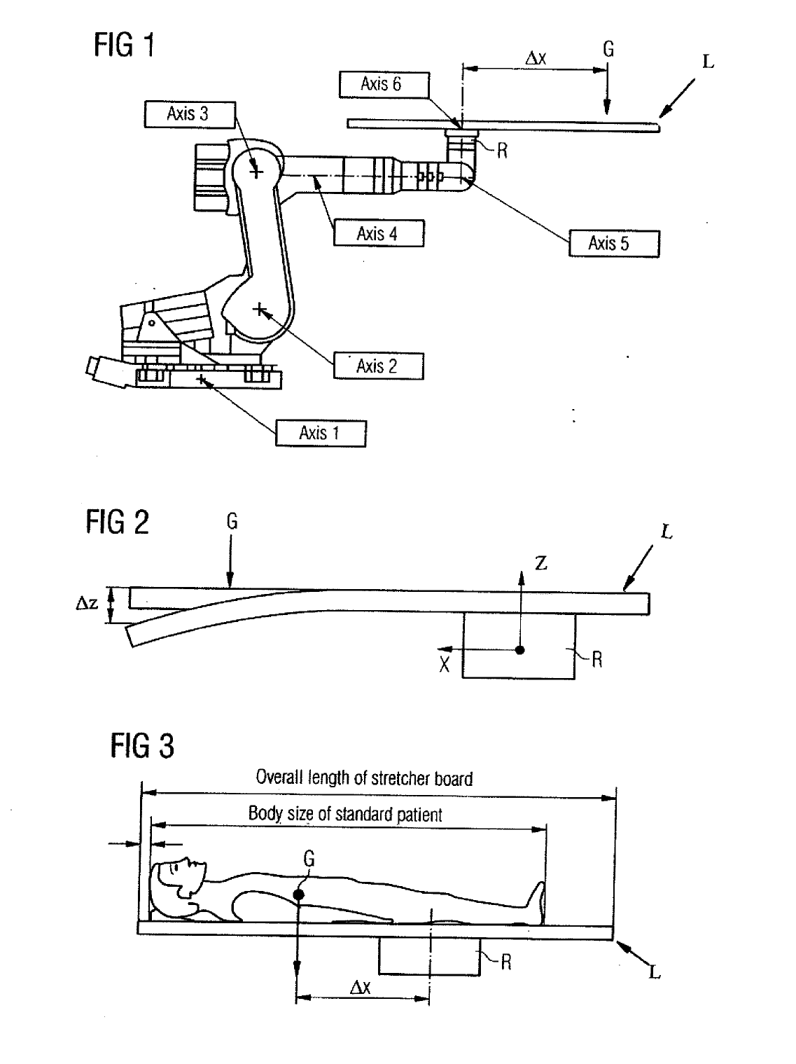

FIG. 1 shows a robot system having a robot arm and/or robot hand R supporting a patient support (stretcher board or patient couch) L. This robot hand R may adjust the reclining position according to inputtable coordinates using a controller. The positioning of a patient on the patient support L leads to a patient support L deformation as a result of his/her weight. FIG. 1 illustrates the weight G and/or the center of gravity of the patient for one example of a point of application. The point of application has a distance Δx from the robot arm and/or the point, where the patient support L is connected to the robot hand R.

The patient support may deform (bend). The stretcher board deformation produced by the weight G of the patient is shown schematically in FIG. 2. The weight G affecting the distance Δx from the robot hand R (and/or from the center point of the connecting region from the robot hand and stretcher board projected onto the x-axis) results in a patient support L bending Δz in the z-direction. The coordinate system introduced above is used here to specify the direction.

The patient support L bending is compensated for by the robot system shown in FIG. 1. The compensation requires that the patient support L deviation Δz be at least approximately determined. The patient support (couch) is adjusted by the robot system using the Δz. FIG. 3 shows a schematic illustration of a patient positioned on the patient support L. The variables in the longitudinal direction (x-direction) are the overall length of the stretcher board, the overall length of the patient and the distance Δx of the patient center of gravity G from the center point of the robot hand R. The patient weight G and the distance Δx of the center of gravity from the robot hand R enable an adequate description of the stretcher board deformation Δz.

An empirically determined formula is used for the description. The starting point is an approach using test functions, for example, an nth degree polynomial (i.e. (x)=ΣAᵢ*x**i, i=0 . . . n) with a suitably selected n (where “n” is a variable). Other test functions as monomials, for example, trigonometric functions may be used. Series of measurements were implemented to determine the coefficients (e.g. Aᵢ) used during the approach, on the basis of which measurements the deformation behavior for different weights was detected by the treatment area. The formula and/or coefficients are then adjusted and/or tailored to the series measurements.

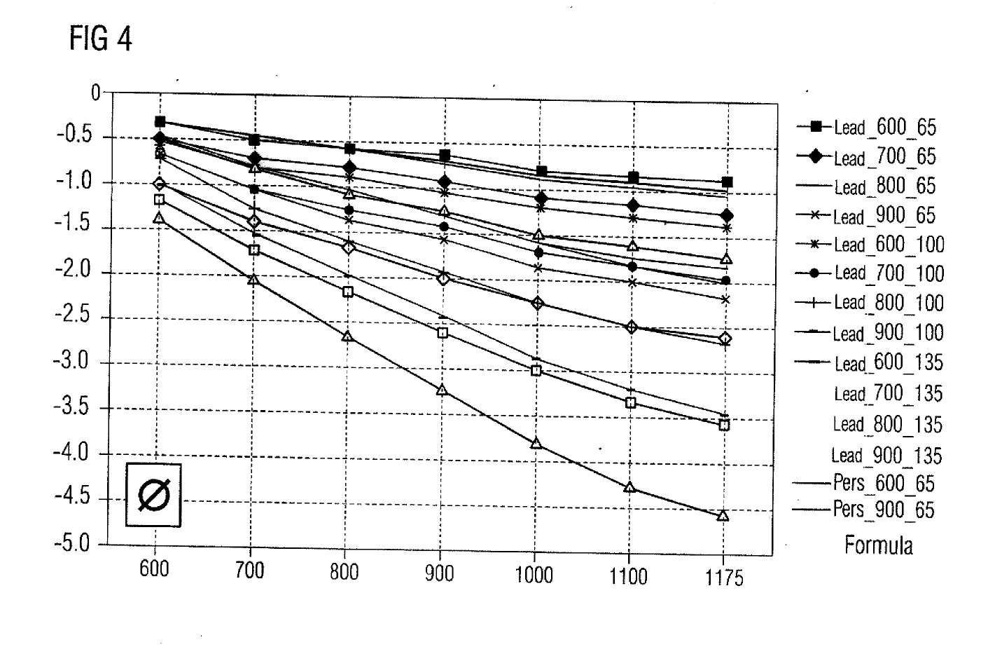

FIG. 4 shows the evaluation of some series of measurements of the stretcher board L determination. With the series of measurements, lead weights were partly used with different center of gravity distances Δx and weights G and partially persons. The notation in the figure firstly reproduces Δx in mm and then the weight G in kg. For example, the Lead_{—}600_{—}65 is a series of measurements for a lead weight at a distance of 600 mm from the center point of the robot hand R, with the weight amounting to 65 kg. In FIG. 4, the x-axis shows here the distance from the center point of the robot hand and the y-axis shows the stretcher board deformation Δz.

The procedure determined Equation 1 for the affected stretcher board:

dz(x)=(0.00000285*(x−500.0)*(x−500.0)−0.007656*(x−500.0)−0.6301)*(G/135.0)*(Δx/900.0)*(Δx/900.0) Equation 1

In one embodiment, with Equation 1, the input variables patient weight H and center of gravity position Δx must be entered. The stretcher board deformation Δz relevant to the treatment is produced by inputting the x-position of the site to be irradiated (affected tissue and/or tumor). The controller of the robot system may use the variable Δz, in order to correct the stretcher board L position.

As can be considered on the basis of FIG. 2, the bending also includes a minimal deviation in the x-direction. The deviation in the x-direction may be compensated for using the afore-described procedure. A deviation in the y-direction is also possible depending on the supporting point of the couch. Corresponding procedures can also be carried out in this instance.

In one embodiment, the stretcher board is mathematically defined such that the bending of the stretcher board may be detected and compensated for by the robot system and/or patient handling system (PHS). Compensation may occur in the course of the exemplary embodiment as a function of the variables “patient weight” and “patient center of gravity position”. The bending and the effect on the position of the tumor may be calculated on the basis of these variables for a determined position on the stretcher board. Other embodiments are immediately apparent to the person skilled in the art from the described conceptional procedure.

1. A method for automatically correcting the position of a patient support for a targeted irradiation of a patient, the method comprising:
determining patient data,
positioning the patient on the patient support,
calculating a patient support deformation, which results from the positioning of the patient on the patient support, based on the patient data, and
adjusting the position of the patient support according to the calculated patient support deformation.

2. The method as claimed in claim 1, wherein the patient data comprises a patient's weight and center of gravity data that relates to the position of the patient's center of gravity.

3. The method as claimed in claim 1, wherein calculating a patient support deformation includes using an empirically obtained formula.

4. The method as claimed in claim 1, wherein a coordinate system is provided, an x-axis is essentially parallel to the non-loaded longitudinal direction of the patient support, the y-axis is parallel to a transverse direction of the patient support, and the z-axis is orthogonal to the x-axis and y-axis.

5. The method as claimed in claim 4, wherein a formula is used, which describes the position change in the z-direction as a function of the x-position, the patient weight, and an item of information relating to the position of the center point of gravity.

6. The method as claimed in claim 5, wherein the information relating to the position of the center of gravity is provided by the x-distance of the center of gravity from a supporting point of the patient support.

7. The method as claimed in claim 5, wherein the function is formed from a superimposition of test functions, the coefficients of which were determined by a patient support-specific adjustment.

8. The method as claimed in claim 1, wherein the adjustment of the patient support is carried out by a robot system.

9. A device for automatically correcting the position of a patient support for a targeted irradiation of a patient, the device comprising:
a calculator that is operable to calculate a stretcher board deformation occurring as a result of positioning the patient on the patient support on the basis of patient data, and
an adjustment device that is operable to adjust the position of the patient support according to the calculated patient support deformation for a targeted irradiation.

10. The device as claimed in claim 9, wherein the adjustment device is a robot system, by which the position of the patient support is changed.

11. The device as claimed in claim 9, wherein the adjustment device is operable to compensate for a patient support deformation.

12. The device as claimed in claim 10, wherein the adjustment device is operable to compensate for a patient support deformation.

13. The device as claimed in claim 9, wherein the patient support deformation is patient support bending.

14. The method as claimed in claim 6, wherein the function is formed from a superimposition of test functions, the coefficients of which were determined by a patient support-specific adjustment.
